(19) United States
(12) Patent Application Publication
(10) Pub. No.: US 2014/0156699 A1
(43) Pub. Date: Jun. 5, 2014

(54) SYSTEM AND METHOD TO AUTOMATICALLY DISCOVER MUTUAL INTERESTS AMONG USERS OF MOBILE WIRELESS DEVICES WITHIN A WIRELESS PERSONAL AREA NETWORK

(71) Applicant: Scott Mills Gray, Sausalito, CA (US)

(72) Inventor: Scott Mills Gray, Sausalito, CA (US)

(21) Appl. No.: 14/094,028

(22) Filed: Dec. 2, 2013

Related U.S. Application Data
(60) Provisional application No. 61/732,298, filed on Dec. 1, 2012.

(51) Int. Cl. H04L 29/08; G06F 17/30

(52) U.S. Cl. CPC H04L 67/306; G06F 17/30477
USPC 707/769; 709/204

(57) ABSTRACT

Systems and methods are described herein that allow users to create Wireless Personal Area Network (WPAN) services that are associated with namespaces. The created services may be stored at a server and associated, on the server, with namespaces. Users of communication devices may search for and download service identifiers of interest. Communication devices within the WPAN may advertise stored service identifiers and scan for other devices having matching service identifiers. As such, users of devices can discover other users having mutual interests.

### CROSS REFERENCE TO PRIOR APPLICATIONS

This application claims priority to and the benefit thereof from U.S. provisional patent application No. 61/732,298, filed Dec. 1, 2012, titled “A System and Method to Automatically Discover Mutual Interests Among Users of Mobile Wireless Devices Within a Personal Area Network,” the entirety of which is hereby incorporated herein by reference.

### FIELD OF THE DISCLOSURE

The present disclosure relates generally to wireless communication, and more particularly to peer-to-peer wireless communication.

### BACKGROUND OF THE DISCLOSURE

Published protocols for wireless mobile devices allow two or more mobile computing and communication devices to communicate in a peer-to-peer(s) fashion when located within a short range (e.g., within 300 m) of each other. These short-range wireless networks are called Wireless Personal Area Networks (WPAN). These WPANs use specific handshaking protocols for the advertising and discovering of data services. With the expanded use of smartphones and social networking, it would be desirable to have a system and method that identifies interest groups and their members as data services.

### SUMMARY OF THE DISCLOSURE

The disclosure provides a system and a method that allow users to create namespaces and attach wireless PAN protocol-specific identifications that multiple users can install for purposes such as, for example, mutual interest discovery using advertising and discovery processes in wireless handshaking protocols.

A method for exchanging service identifiers in a wireless personal area network (WPAN) is described herein. The method may include retrieving a stored service identifier from a memory of a first communication device, the at least one service identifier being associated with one or more of a namespace of topics, an interest group, a social group, and a social network; scanning the WPAN for at least one service identifier matching the stored service identifier; identifying a service identifier that matches the stored service identifier, and displaying the matching service identifier on the first communication device, wherein the matching service identifier is stored on a second communication device.

The method may further include displaying device identification data on the first communication device, the device identification data being associated with the second communication device.

According to some aspects of the disclosure, the method further may further include advertising the stored service identifier within the WPAN.

According to some aspects of the disclosure, the method further may further include establishing a connection to a server; searching the server for one or more additional service identifiers; and downloading said stored service identifier from the server to the first communication device.

According to some aspects of the disclosure, searching the server may comprise searching for a keyword associated with the stored service identifier.

According to some aspects of the disclosure, searching the server may comprise browsing a list of names associated with service identifiers stored at the server.

A method for maintaining a database of service identifiers in a WPAN is also described herein. The method may include generating one or more service, each of the one or more service identifiers each being associated with a namespace; storing the one or more service identifiers in a databases; and providing a search component enabling users of one or more communication devices to search for the one or more service identifiers in the database.

According to some aspects of the disclosure, the namespace may be associated with one or more of a topic, an interest group, a social group, and a social network.

According to some aspects of the disclosure, providing the search component may comprise providing a user interface, the user interface comprising a browse function or a keyword search function.

A method for exchanging service identifiers in a wireless personal area network (WPAN) is also described herein that may include searching, by a first communication device, a server for at least one service identifier; and downloading an storing, on the first communication device, the at least one service identifier, wherein the searching comprising at least one of browsing or keyword searching one or more namespaces associated with each of one or more service identifiers.

According to some aspects of the disclosure, the namespace may be associated with one or more of a topic, an interest group, a social group, and a social network.

According to some aspects of the disclosure, the method may further comprise operating in a first mode to scan the WPAN for at least one service identifier matching a stored service identifier; and operating in a second mode to advertise, via the WPAN, the stored service identifier. The method may include operating in the first mode and the second mode simultaneously.

According to some aspects of the disclosure, the method may also include receiving notification of at least one matching service identifier; and displaying the at least one matching service identifier and an identification of a device storing the matching service identifier.

According to some aspects of the disclosure, operating in the second mode may further comprise advertising data associated with the stored service identifier.

According to some aspects of the disclosure, the method may further comprise searching the server for at least one additional service identifier, and downloading and storing the at least one additional service identifier. Searching the server for at least one additional service identifier may searching for a keyword associated with the stored service identifier, in accordance with some aspects of the disclosure. According to some aspects of the disclosure, searching the server for at least one additional service identifier may comprise browsing a list of names associated with service identifiers stored at the server.

According to some aspects of the disclosure, the WPAN may comprise at least one of a Bluetooth network and a Wi-Fi network.

### BRIEF DESCRIPTION OF THE DRAWINGS

Aspects of the disclosure will be better understood after reading the following description when considered with the drawings in which:

FIG. 1 is a schematic illustrating the concept of a Wireless Personal Area Network (WPAN);

FIG. 2 illustrates an example of a communication device;

FIG. 3 illustrates an example of a server device;

FIG. 4 illustrates an example of a system implementing aspects of the disclosure;

FIG. 5 is another example of a system implementing aspects of the disclosure;

FIG. 6 is an example of notifications presented on communication devices in accordance with aspects of the disclosure;

FIG. 7 is a flowchart illustrating an example of a method of downloading service identifiers; and

FIG. 8 is a flowchart illustrating an example of a method of exchanging service identifiers.

### DETAILED DESCRIPTION OF THE DISCLOSURE

Aspects of the disclosure, as described in detail below, are directed to systems and methods that allow users to create Wireless Personal Area Network (WPAN) service identifiers that are associated with namespaces. The created service identifiers may be stored at a server and associated, on the server, with namespaces. Users of communication devices may search for and download service identifiers of interest. Communication devices within the WPAN may advertise stored service identifiers and scan for other devices having matching service identifiers. As such, users of devices can discover other users having mutual interests.

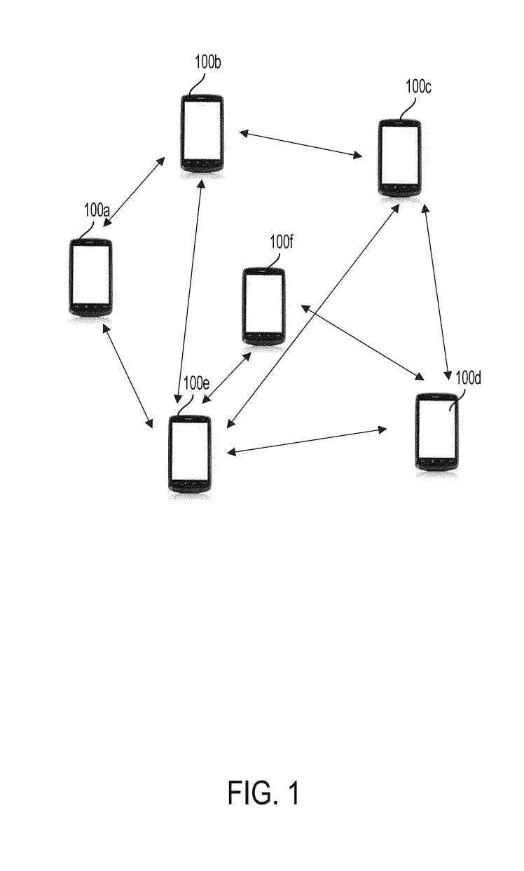

FIG. 1 is a schematic diagram illustrating an example of a WPAN. Using radio communication protocols each communication device 100 (100a to 100f) is capable of pairwise asynchronous data sharing. The communication devices 100 may be configured to communicate with each other using one or more short-range communication protocols such as, for example, Wi-Fi, Bluetooth, and/or any other short-range communication protocol. In accordance with some aspects of the disclosure, any device within the range of a selected short-range communication protocol would automatically be a part of the WPAN and able to listen for data from and advertise data through the WPAN. In other aspects of the disclosure, users of the device may optionally join the WPAN when within range As shown in FIG. 1, a plurality of communication devices 100 within a defined range of each other may communicate directly via the radio communication protocol(s). Each communication device 100 may be, for example, a mobile phone, a smartphone, a personal digital assistant (PDA), a tablet computer, a game console, and/or any other communication device.

In accordance with some aspects of the disclosure, one or more of the communication devices 100 may act as a server, providing a client-server architecture. The communication device 100 that functions as a server device may be configured to generate and store one or more unique service identifiers. For example, in a Bluetooth WPAN, the unique service identifiers may include a 16-bit to 128-bit universally unique identifier (UUID). Other types of unique service identifiers may be used. The service identifiers may be associated with a namespace of topics, interest groups, social groups, social networks, etc. that have been created by users. In accordance with some aspects, an external server device, not shown in FIG. 1, may be used to implement the server functions. Each communication device 100 may connect to an external server device (not shown) via a network connection, such as, for example, the Internet, a local area network, a wide area network, and the like.

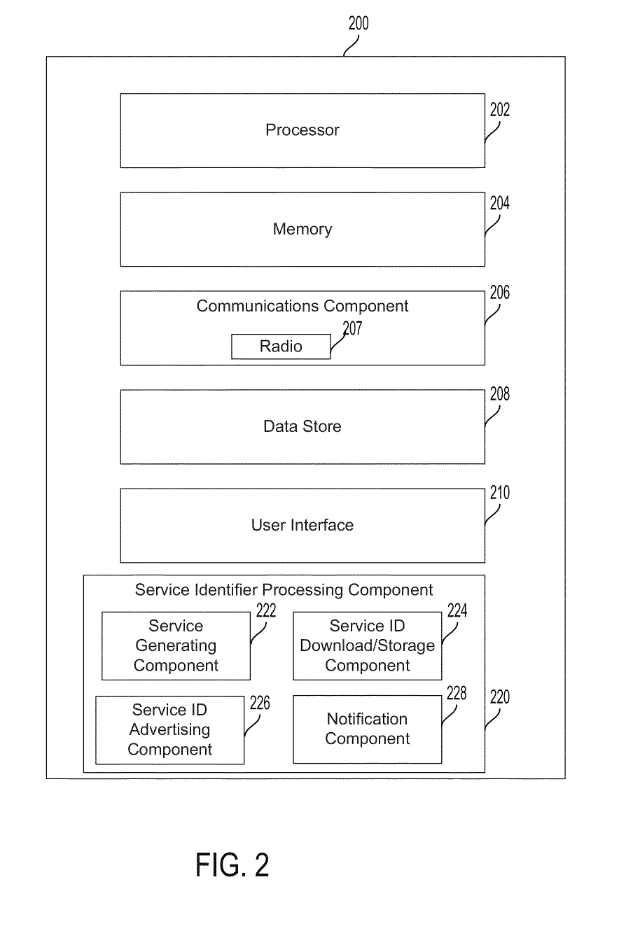

Referring now to FIG. 2, an example of a communication device 200 is shown. The communication device 100 (shown in FIG. 1) may be configured as, or include the communication device 200. Communication device 200 includes a processor 202 for carrying out processing functions associated with one or more components and functions described herein. Processor 202 can include a single set, or multiple sets of processors or multi-core processors. Moreover, processor 202 can be implemented as an integrated processing system and/or a distributed processing system.

Communication device 200 further includes a memory 204, such as for storing data and/or local versions of applications being executed by processor 202. The memory 204 may include a computer readable medium. Memory 204 can include any type of memory usable by a computer, such as random access memory (RAM), read only memory (ROM), tapes, magnetic discs, optical discs, volatile memory, non-volatile memory, and the like, and any combination thereof.

Further, communication device 200 may include a communications component 206 that provides a means for establishing and maintaining communications over one or more communication links with one or more parties utilizing hardware, software, and services as described herein. Communications component 206 may carry communications between components on communication device 200, as well as between the communication device 200 and external devices, such as devices located across a network and/or devices serially or locally connected to communication device 200 (e.g., communication devices 100, shown in FIG. 1). For example, communications component 206 may include one or more buses, and may further include transmit chain components and receive chain components associated with a transmitter and receiver, respectively, operable for interfacing with external devices. In some aspects, communications component 206 may include a radio 207 having a preset or adjustable communication range. The radio 207 may include, e.g., a software defined radio (SDR). For example, radio 207 may operate at a maximum range of approximately 300 meters to enable communications devices within the range to communicate with each other. 300 meters is meant only as an example of setting a maximum range. The maximum range may be greater (or less) than 300 meters.

Additionally, communication device 200 may further include a data store 208, which may include any suitable combination of hardware and/or software that provides for mass storage of information and programs employed in connection with aspects described herein. The data store 208 may include a computer readable medium. The data store 208 may include a database. For example, data store 208 may include a data repository for applications not currently being executed by processor 202. In some aspects, data store 208 may be located within memory 204.

Communication device 200 may additionally include a user interface component 210 operable to receive inputs from a user of communication device 200. The user interface component 210 may be further operable to generate outputs for presentation to the user. User interface component 210 may include one or more input devices, including but not limited to a keyboard, a number pad, a mouse, a touch-sensitive display, a navigation key, a function key, a microphone, a voice recognition component, a game controller, a still camera, a video camera, an audio recorder, and/or any other mechanism capable of receiving an input, or any combination thereof. Further, user interface component 210 may include one or more output devices, including but not limited to a display, a speaker, a haptic feedback mechanism, a video projector, a printer, a game controller, or any other mechanism capable of presenting an output, or any combination thereof.

Communication device 200 may also include a service identifier processing component 220. Service identifier processing component 220 may comprise a service generating component 222, a service ID download/storage component 224, a service ID advertising/scanning component 226, and a notification component 228. The service generating component 222 may be configured to enable users of communication device 200 to create services that may be associated with, for example, a namespace of topics, interest groups, subcultures, cliques, events, etc. The generated services may be stored on a server device (not shown) that may be configured to associate each new service with a unique service identifier. Accordingly, users of communication devices capable of connecting to the server can search for and install service identifiers related to the users' interests and any related information associated with the service identifier. The service ID download/storage component 224 may be configured to enable a user to contact a server to search for service identifiers of interest and download such service identifiers to communication device 200. The downloaded service identifiers may be stored, for example, in memory 204 or data store 208. In addition to the service identifiers, the service ID download/storage component 224 may be configured to download any group, affiliation, attribute, etc. information associated with the service identifier.

Service ID advertising/scanning component 226 may be configured to facilitate the advertising of identifiers stored on device 200 and also to scan the airwaves to detect other devices (e.g., communication devices 100, shown in FIG. 1) that have the same identifiers. For example, communication device 200 may operate in a central mode, wherein it may, via its advertising/scanning component 226, monitor the airwaves for devices (e.g., communication devices 100, shown in FIG. 1) that may be in range that have stored thereon the same identifiers stored on communication device 200. Communication device 200 may also operate in a peripheral mode wherein the communication device 200 may broadcast its stored service identifiers.

Service identifier processing component 220 may also include a notification component 228 that is configured to present a notification upon detection of other devices (e.g., communication devices 100, shown in FIG. 1) within a network that have stored thereon the same service identifiers stored on communication device 200. For example, the notification component 228 may cause a visual, audio, text, olfactory, and/or other type of notification to be presented to a user of communication device indicating that matching service identifiers have been detected. The notification may include, for example, an identification of the device (e.g., communication device 100, shown in FIG. 1) having a matching service identifier(s), a namespace (or interest group, social network, etc.) associated with the service identifier, and/or other identifying information.

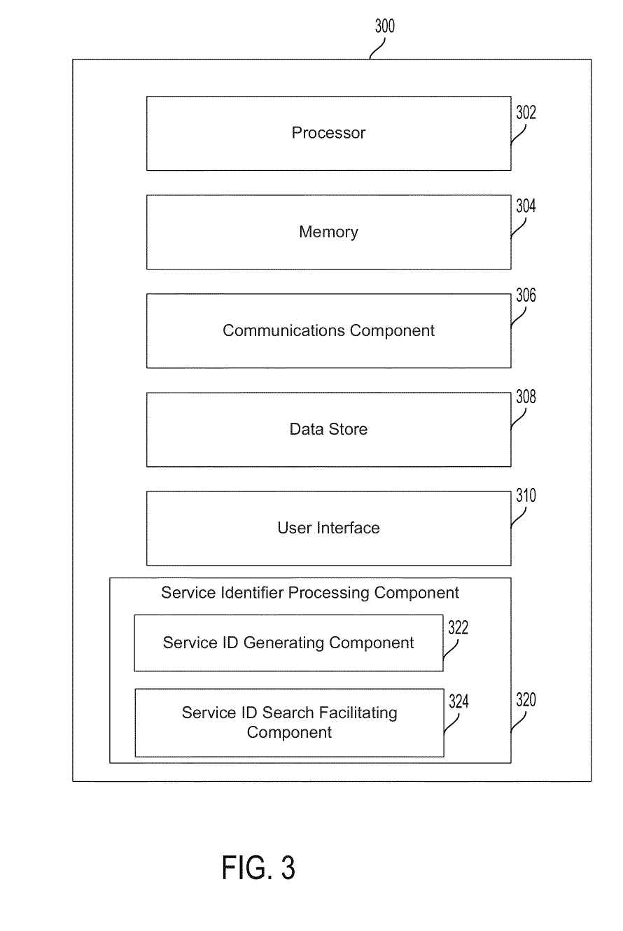

FIG. 3 illustrates an example of a server 300 that may be configured to implement various aspects of the disclosure. The server 300 may include a processor 302, memory 304, communications component 306, data store 308, and a user interface component 310. These components may operate in a manner similar to the operation of their corresponding components in communication device 200. As such, a detailed description of these components is not included.

Server 300 may also include a service identifier processing component 320. The service identifier processing component 320 may include a service identifier generating component 322 and a service identifier search facilitating component 324. Service identifier generating component 322 may be configured to generate WPAN service identifiers to associate the created service identifiers with, for example, a name or namespace of topics, interest groups, social networks, etc. created by users. Service identifier search facilitating component 324 may be configured to present search options to communication devices (e.g., communication devices 100 or 200, shown in FIGS. 1 and 2) for searching or browsing the service identifier database. For example, in conjunction with user interface 310, the service identifier search facilitating component 324 may present a graphical user display providing search and browsing options accessible to a user upon connecting to server 300.

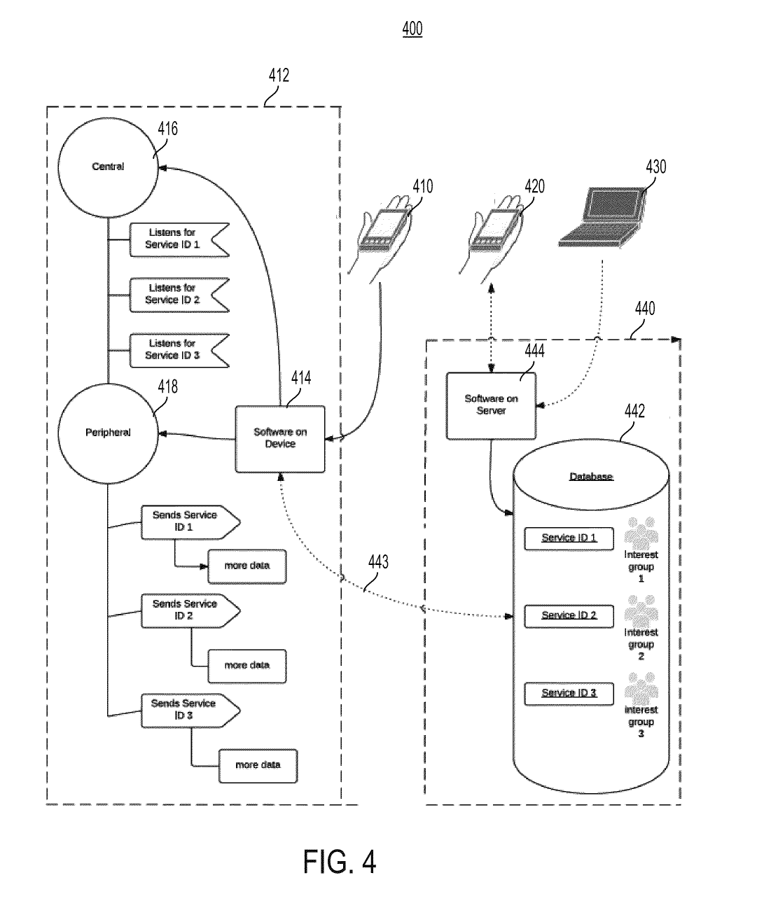

Turning now to FIG. 4, an example of a system 400 implementing aspects of the disclosure is shown. The system 400 comprises one or more of a plurality of communication devices 410, 420, and 430 that may be communicatively coupled to a server 440. Each of the plurality of communication devices 410 may include a service identifier processing component, as described above with respect to FIG. 2. Various functions of the service identifier processing components are shown at 412. The functions may be implemented as software 414 stored on each communication device. Among other functions, the software 414 may facilitate a search for service identifiers stored in database 442 associated with server 440, and for the retrieval of desired service identifiers from database 442, as shown at 443. A communication device may be configured to perform both central 416 and peripheral 418 functions. When performing central functions, the communication device may be configured to listen for service identifiers that the communication device has previously stored in memory. In this example, the communication device may listen for three different service identifiers. In performing its peripheral functions, the communication device may advertise its stored service identifiers along with any additional data to be associated with the service identifiers.

Server 440 may be configured with software 444 that provides an option to users for searching database 442 for service identifiers of interest. The software may also be configured to generate service identifiers and to associate generated service identifiers with interest groups, topics, etc.

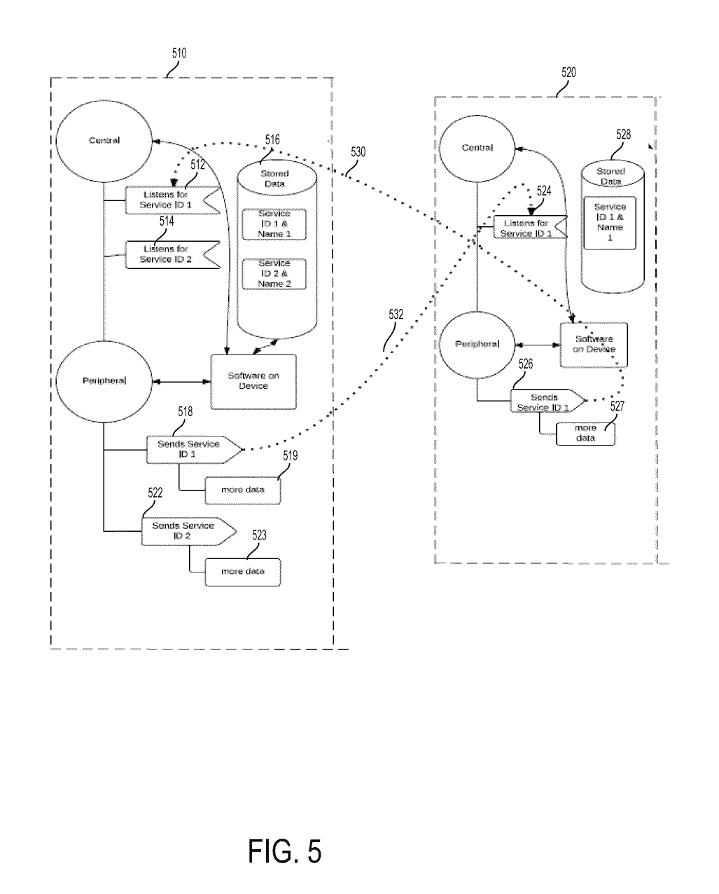

Referring now to FIG. 5, an example of two communication devices 510 and 520 exchanging communication signals is shown. Communication devices 510 and 520 may be, for example, two mobile wireless devices within radio transmission and reception range (e.g., in a WPAN). Device 510 is listening in Central Mode for Service ID 1 and Service ID 2, as shown at 512 and 514. Service ID 1 and Service ID 2 may be associated with Name 1 and Name 2, respectively, and stored in storage component 516. In Peripheral Mode, device 510 may advertise for Service ID 1 and Service ID 2, as shown at 518 and 522. In some aspects, the device 510 may have additional data to associate with a service identifier, as shown at 519, 523. Service ID 1, Service ID 2, Name 1, and Name 2 may be installed by the user of communication device 510 from a server, such as the server described above with respect to FIGS. 3 and 4.

In this example, communication device 520 may be configured to scan for and advertise Service ID 1 only, as shown at 524 and 526, respectively. Service ID 1 and Name 1 may be stored in storing component 528. Similar to communication device 510, communication device 520 may have additional data associated with a service identifier, as shown at 527. The additional data may include, for example, data about the user (e.g., age, gender, education, hobbies, etc.) of the communication device, data about the communication device (e.g., manufacturer, model, etc.), and the like. The dotted arrows labeled 530 and 532 illustrate the exchange of data occurring between communication devices 510 and 520 after matching mutual Service ID 1.

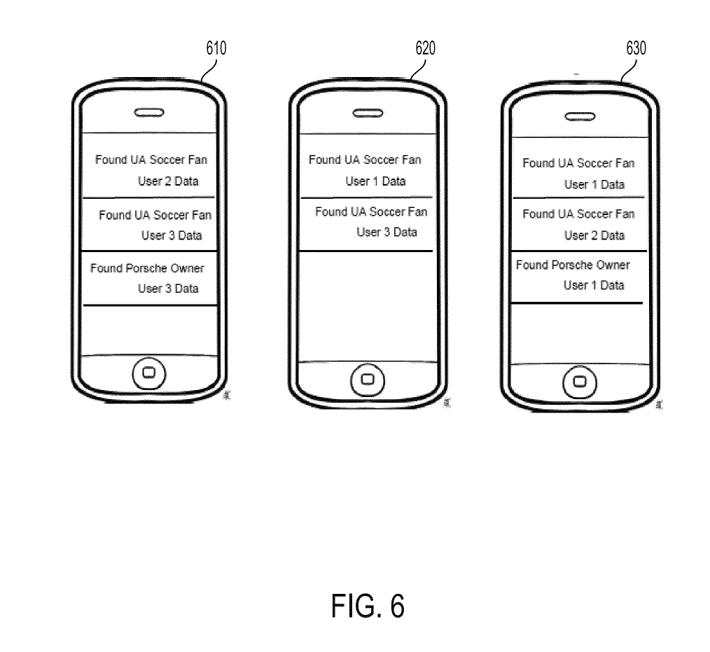

Now referring to FIG. 6, an example situation is illustrated with three communication devices 610, 620, and 630 located in a WPAN. The devices 610, 620, and 630 may be associated with users, User 1, User 2, and User 3, respectively. The three devices may perform both central and peripheral roles. In this example, communication device 610 and communication device 630 may each have stored thereon a service identifier associated with the names “UA Soccer Fan” and “Porsche Owner.” Device 620 may have stored thereon the service identifier associated with the name “UA Soccer Fan.” As shown in FIG. 6, notifications may be displayed on each device showing the names and user data for each service identifier found while scanning.

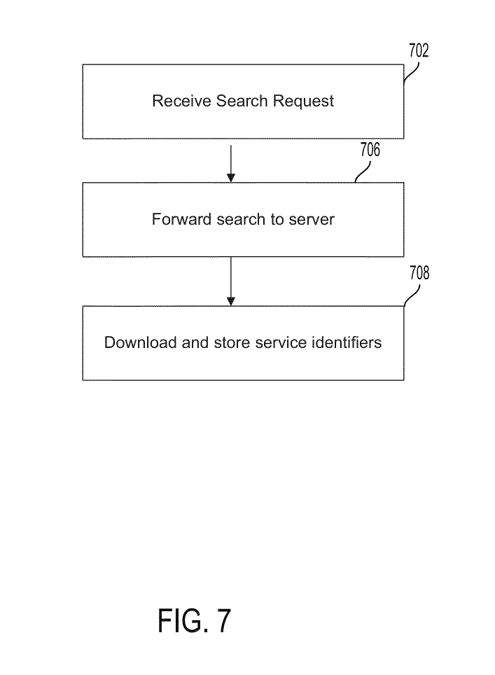

FIG. 7 is a flowchart illustrating a process 700 for searching for service identifiers to be monitored. As shown at 702, a search request may be received by the communication device. That is, a user may issue a command to initiate a search for a service identifier. As shown at 704, the search request may be forwarded to a server device (not shown) that stores service identifiers. The server device may be located within a WPAN, or it may be located at a remote location. The search request may include, for example, a keyword search based on a name associated with the service identifier(s) the user is interested in. In other aspects, the search request may include a request to browse a list of available service identifiers. As shown at 706, those service identifiers of interest may be downloaded from the server device and stored on the communication device.

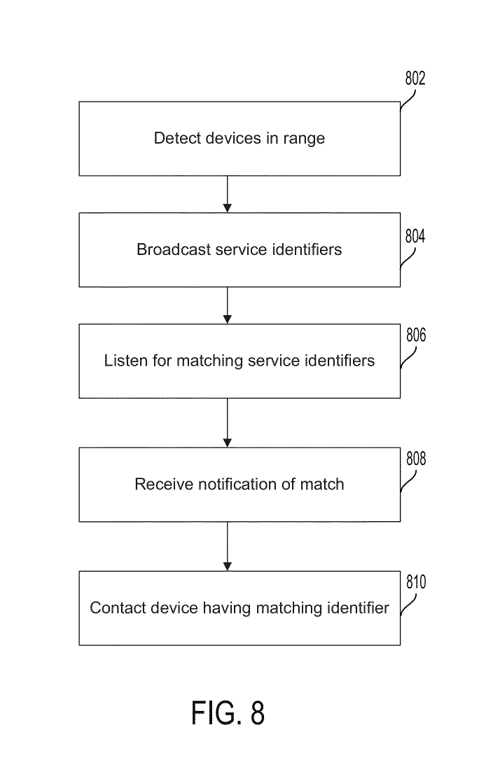

FIG. 8 is a flowchart illustrating a process 800 for communicating service identifiers among communication devices (e.g., communication devices 100a and 100b, shown in FIG. 1) in a wireless PAN. As shown at 802, a first communication device (e.g., communication device 100a) may detect that it is in range of another communication device (e.g., communication device 100b). As shown at 804, the first communication device may be configured to broadcast service identifiers stored on the communication device. The first communication device may also be configured to listen for service identifiers being broadcast by other devices in the WPAN (e.g., communication devices 100b to 100f), as shown at 806. The first communication device may be configured to listen only for those service identifiers matching its own stored service identifiers. As shown at 808, the first communication device may receive notification that a service identifier matching one or more of the first communication device's stored service identifiers has been detected. Upon receipt of the notification, the first communication device may be configured to contact the device having matching service identifiers, as shown at 810. For example, the first communication device may establish a connection with the device or devices having matching service identifiers to exchange data associated with the service identifier.

The advantages of the present disclosure include, without limitation, the ability for users to find out the interests of nearby users in a WPAN via peer-to-peer radio communication, once service identifiers and names have been downloaded and installed.

While the aspects of the disclosure have been described in terms of exemplary embodiments, those skilled in the art will recognize that the aspects described herein can be practiced with modifications in the spirit and scope of the appended claims. These examples given above are merely illustrative and are not meant to be an exhaustive list of all possible designs, embodiments, applications or modifications of the described aspects of the disclosure.

A “communication device,” as used in this disclosure, means any machine, device, circuit, component, or module, or any system of machines, devices, circuits, components, modules, or the like, which are capable of transmitting and/or receiving data according to one or more instructions, such as, for example, without limitation, a processor, a microprocessor, a central processing unit, a general purpose computer, a super computer, a personal computer, a laptop computer, a palmtop computer, a smart phone, a cellular telephone, a tablet, a web-book, a notebook computer, a desktop computer, a workstation computer, a server, or the like.

While the use of a personal area network (PAN) is described herein, aspects of the disclosure may be implemented via other types of networks. A “network,” as used in this disclosure, means any combination of software and/or hardware, including any machine, device, circuit, component, or module, or any system of machines, devices, circuits, components, modules, or the like, which are capable of transporting signals from one location to another location, where the signals may comprise information, instructions, data, and the like. A network may include, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), or the like, any of which may be configured to communicate data via a wireless and/or a wired communication medium.

Communications among devices described in this disclosure may be performed of a communication link. A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like. Techniques for implementing such communications links are known to those of ordinary skilled in the art.

The terms “including,” “comprising,” “having,” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A computer-readable medium may be used to implement the functions described herein. A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

What is claimed is:

1. A method for exchanging service identifiers in a wireless personal area network (WPAN), the method comprising:
retrieving and advertising a stored service identifier from a memory of a first communication device, the at least one service identifier being associated with one or more of a namespace of topics, an interest group, a social group, and a social network;
scanning the WPAN for at least one service identifier matching the stored service identifier;
identifying a service identifier that matches the stored service identifier; and
displaying the matching service identifier on the first communication device, wherein the matching service identifier is stored on a second communication device.

2. The method of claim 1, further comprising:
displaying device identification data on the first communication device, the device identification data being associated with the second communication device.

3. The method of claim 1, wherein the WPAN comprises at least one of a Bluetooth network and a Wi-Fi network

4. The method of claim 1, further comprising:
advertising the stored service identifier within the WPAN.

5. The method of claim 1, further comprising:
establishing a connection to a server;
searching the server for one or more additional service identifiers; and
downloading said stored service identifier from the server to the first communication device.

6. The method of claim 1, wherein searching the server comprises searching for a keyword associated with the stored service identifier.

7. The method of claim 1, wherein searching the server comprise browsing a list of names associated with service identifiers stored at the server.

8. A method for maintaining a database of service identifiers in a WPAN, the method comprising:
generating one or more service identifiers, each of the one or more service identifiers being associated with an end user created namespace of topics;
storing the one or more service identifiers in a database; and
providing a search component enabling users of one or more communication devices to search for the one or more service identifiers in the database.

9. The method of claim 8, wherein the namespace of topics is associated with one or more of an interest group, a social group, and a social network.

10. The method of claim 8, wherein providing the search component comprises providing a user interface, the user interface comprising a browse function or a keyword search function.

11. A method for exchanging service identifiers in a wireless personal area network (WPAN), the method comprising:
searching, by a first communication device, a server for at least one service identifier; and
downloading and storing, on the first communication device, the at least one service identifier,
wherein the searching comprises at least one of browsing and keyword searching one or more namespaces associated with each of one or more service identifiers.

12. The method of claim 11, wherein namespace is associated with one or more of a topic, an interest group, a social group, and a social network.

13. The method of claim 11, further comprising:
operating in a first mode to scan the WPAN for at least one service identifier matching a stored service identifier; and
operating in a second mode to advertise, via the WPAN, the stored service identifier.

14. The method of claim 13, further comprising operating in the first mode and the second mode simultaneously.

15. The method of claim 13, further comprising:
receiving notification of at least one matching service identifier; and
displaying the at least one matching service identifier and an identification of a device storing the matching service identifier.

16. The method of claim 13, wherein operating in the second mode further comprises advertising data associated with the stored service identifier.

17. The method of claim 11, further comprising:
searching the server for at least one additional service identifier; and
downloading and storing the at least one additional service identifier.

18. The method of claim 17, wherein searching the server for at least one additional service identifier comprises searching for a keyword associated with the stored service identifier.

19. The method of claim 17, wherein searching the server for at least one additional service identifier comprises browsing a list of names associated with service identifiers stored at the server.

20. The method of claim 11, wherein the WPAN comprises at least one of a Bluetooth network and a Wi-Fi network.
